(19) United States
(12) Patent Application Publication
(10) Pub. No.: US 2011/0074341 A1
(43) Pub. Date: Mar. 31, 2011

(54) NON-CONTACT INTERFACE SYSTEM

(75) Inventors: Earl Jensen, Santa Clara, CA (US); Aron Mason, San Mateo, CA (US)

(73) Assignee: KLA- Tencor Corporation, San Jose, CA (US)

(21) Appl. No.: 12/567,664

(22) Filed: Sep. 25, 2009

(51) Int. Cl. H02J 17/00; H02J 7/00

(52) U.S. Cl. 320/108; 307/104

(57) ABSTRACT

An interface system for a sensor wafer may comprise a sensor wafer having a substrate. One or more sensors may be mounted to the substrate. An electronics module may be mounted to the substrate and coupled to the one or more sensors. An energy storage device may be mounted to the substrate and coupled to the electronics module. A secondary coil may be attached to a surface of the sensor wafer, and coupled to the electronics module of the sensor wafer, having a diameter of at least 50 millimeters. A primary coil may be attached to a front opening universal pod (FOUP). The primary coil, may situated and oriented in the FOUP such that the primary coil is concentric with the secondary coil and at least 8, but less than 12 millimeters from the sensor wafer when the sensor wafer is stored in a slot in the FOUP.

### BACKGROUND OF INVENTION

Sensor wafers are used to obtain non-invasive, in-situ measurements of actual physical and electrical properties of plasma within an operational plasma processing environment. These sensor wafers are configured to collect, process, and store data received during measurement of the plasma. These sensor wafers may include devices to measure thermal, optical, and electromagnetic properties of the process environment. During the measurement process, these sensor wafers may be exposed to harsh conditions such as excessive heat, corrosive chemicals, and bombardment by high energy ions, and high levels of electromagnetic and other radiative noise. It is important for the sensor wafer to remain resilient in the harsh environment associated with in-situ measurement of plasma.

Sensor wafers are currently housed and stored in a front operating universal pod (FOUP) during the in-situ process survey. A FOUP is a specialized plastic enclosure designed to hold wafers securely and safely in a controlled environment, and configured to allow the wafers to be removed for processing or measurement by tools equipped with appropriate load ports and robotic handling systems. A FOUP may be used to communicate with a sensing wafer and recharge the sensing wafer's batteries during the process survey. Existing communication between a FOUP and sensor wafer is based on operation with a pair of coupled inductors. These coupled inductors are equivalent to an air-core transformer. The physical implementation of these inductors is accomplished by having one coil, the secondary, embedded in the sensor wafer and a second coil, the primary, on a substrate in close proximity. The coupling coefficient, k, is heavily reduced as the distance between the primary and secondary coils grows. Hence, the induced current in the secondary coil and the back reflected impedance of the secondary coil rapidly decrease as a function of distance. In order to obtain an optimal transfer of power and data between the primary and secondary coils, the primary coil must be in close proximity with the secondary coil in the sensor wafer.

The forward power transfer between the primary coil and the secondary coil provides power for the re-charging of the sensor wafer batteries. On-Off-Key (OOK) modulation is used to encode the carrier frequency (RF) from the primary coil to the secondary coil with a data stream that can be detected by the sensor wafer as a command. Communication from the wafer/secondary coil to the FOUP/primary coil may be accomplished by altering the load (e.g., impedance) of the secondary coil such that reflection from the secondary coil to the primary coil may be detected by the FOUP as an AM modulated bit stream.

The current trend amongst wafer sensors and FOUPs is to scale down the size of primary and secondary coils, thus reducing the resistance associated with the size of the coil. However, the close proximity between the primary coil and the sensor wafer necessitated by reduced coil diameter, as well as the moving parts and exposed electronics within the enclosed FOUP all contribute to particle generation. Particle generation affects the accuracy of the survey process and creates a barrier for entry into particle sensitive applications.

It is within this context that embodiments of the present invention arise.

### BRIEF DESCRIPTION OF THE DRAWINGS

The teachings of embodiments of the present invention can be readily understood by considering the following detailed description in conjunction with the accompanying drawings, in which:

FIG. 1A is a top view schematic diagram illustrating the structure of a sensor wafer that may be used in conjunction with embodiments of the present invention

FIG. 1B is a cross-sectional view schematic diagram illustrating the structure of the sensor wafer of FIG. 1A.

FIG. 1C is a bottom view schematic diagram illustrating the structure of the sensor wafer of FIGS. 1A-1B.

FIG. 2A is cross-sectional schematic diagram of an interface system for measuring process parameters according to an embodiment of the present invention.

FIG. 2B is a three-dimensional view schematic diagram of an interface system for measuring process parameters according to an embodiment of the present invention.

FIG. 2C is a side cross-sectional schematic diagram of an alternative interface system for measuring process parameters according to an embodiment of the present invention

### DESCRIPTION OF THE SPECIFIC EMBODIMENTS

Embodiments of the present invention overcome the disadvantages associated with the prior art by increasing the diameters of the primary and secondary coils used to charge and/or communicate with a sensor wafer. As a result of the increased coil size, a large inter-coil spacing may be used.

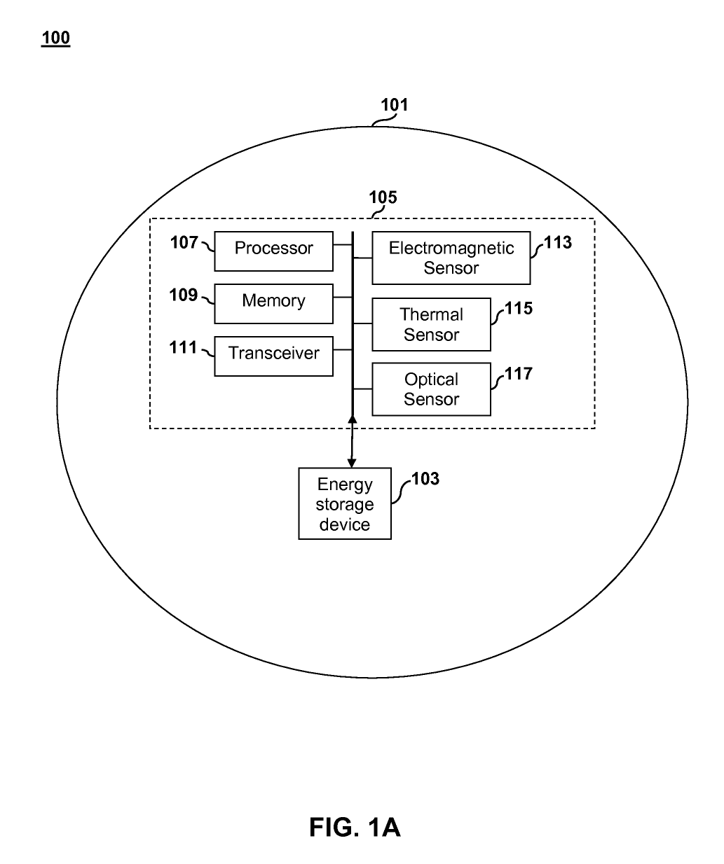

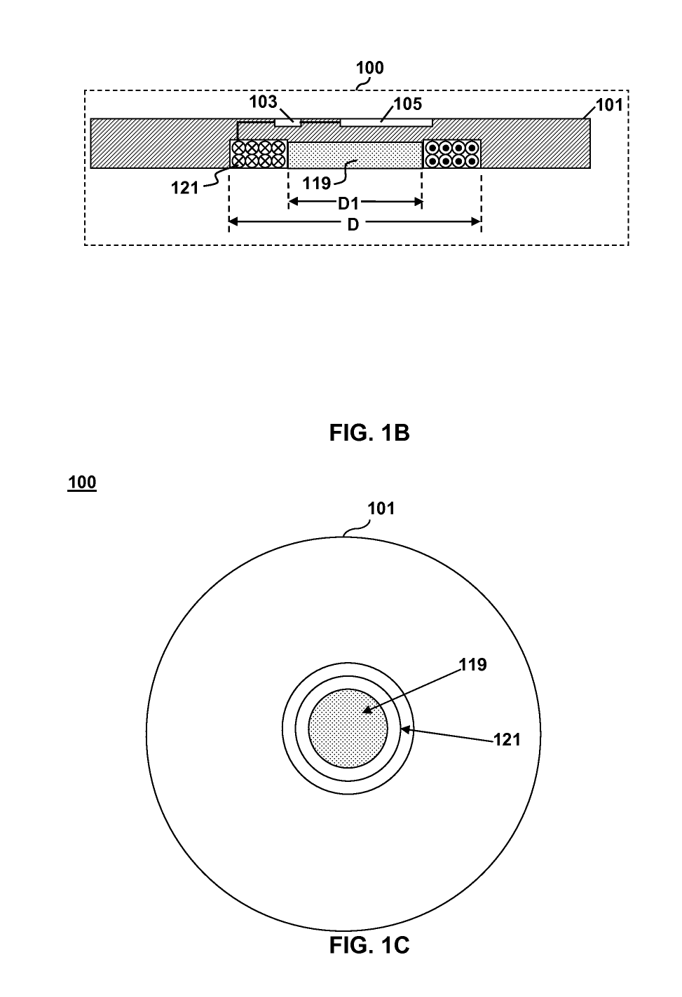

FIGS. 1A-1C illustrate an example of a sensor wafer 100 configured to measure process parameters in a system for processing wafers during semiconductor fabrication. The sensor wafer 100 may include a substrate 101, with an energy storage device 103 and measurement electronics 105 mounted to the substrate 101. By way of example, and not by way of limitation, the measurement electronics 105 of the sensor wafer 100 may be implemented with a processor module 107, a main memory 109, a transceiver 111, and one or more sensors 113, 115, 117. The substrate 101 may have the same dimensions as a production substrate that is processed by a semiconductor device fabrication system, e.g., 150 mm, 200 mm, or 300 mm.

The energy storage device 103 preferably supplies electrical energy at an operating voltage, current handling and has an energy storage capacity that is sufficient to power the electronics 105 on the sensor wafer 100 over a period of time for which the sensor wafer is expected to operate. Furthermore, it is often desirable for the energy storage device 103 thin enough to fit within a recess in the substrate 101 and have a sufficiently small footprint to allow room for the measurement electronics, memory, transceiver and sensors. It is further desirable for the energy storage device 103 to be made of materials suitable for use in the environment of a semiconductor wafer processing tool in which the sensor wafer 100 is to be used. By way of example, and not by way of limitation, the energy storage device 103 may be a rechargeable battery, such as a lithium ion battery. Other suppliers of suitable batteries include Front Edge Technology, Inc. of Baldwin Park, Calif., Infinite Power Solutions of Littleton, Colorado and Cymbet Corporation of Elk River, Minn. One example of a Lithium ion battery is a 4.2 LiPON solid state lithium ion battery from Infinite Power Solutions of Littleton, Colo. The energy storage device 103 may be supplemented with an energy harvesting device, again by way of example, and not by way of limitation, a thermopile generator or photovoltaic cell.

The processor module 107 may be configured to execute instructions stored in the main memory 109 in order for the sensor wafer 100 to properly measure process parameters. The main memory 109 may be in the form of an integrated circuit, e.g., RAM, DRAM, ROM and the like. The transceiver 111 allows the sensor wafer 100 to communicate data stored in the memory 109 to an external processing system or to receive data from an external system for storage in the memory 109 or processing by the processor module 107. The energy storage device 103 provides power for operating the measurement electronics 105 and sensors 113, 115, 117. The sensors may include an electromagnetic sensor 113 to measure electromagnetic properties of a given plasma, a thermal sensor 115 to measure thermal properties of a given plasma, and an optical sensor 117 to measure optical properties of a given plasma.

As seen in FIG. 1B and FIG. 1C a secondary inductive coil 121 may be mounted to a bottom of the substrate 101. The secondary coil includes a plurality of spiral windings of electrically conductive (e.g., copper) wire that are electrically insulated from each other to prevent shorting. The secondary inductive coil 121 may communicate through induction with another primary inductive coil connected to a charging station on a substrate carrier such as a front opening universal pod (FOUP). For convenience, the secondary inductive coil 121 coupled to the sensor wafer 100 will be referred to as the wafer coil 121 and the primary inductive coil coupled to the FOUP will be referred to as the FOUP coil.

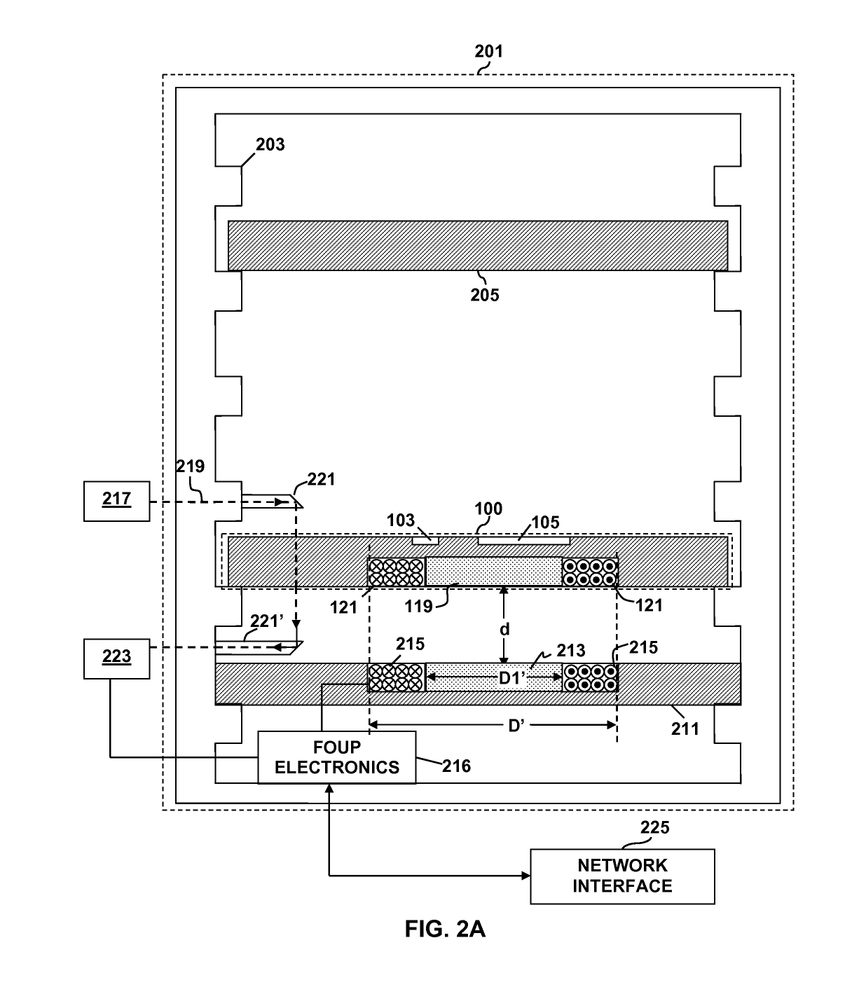

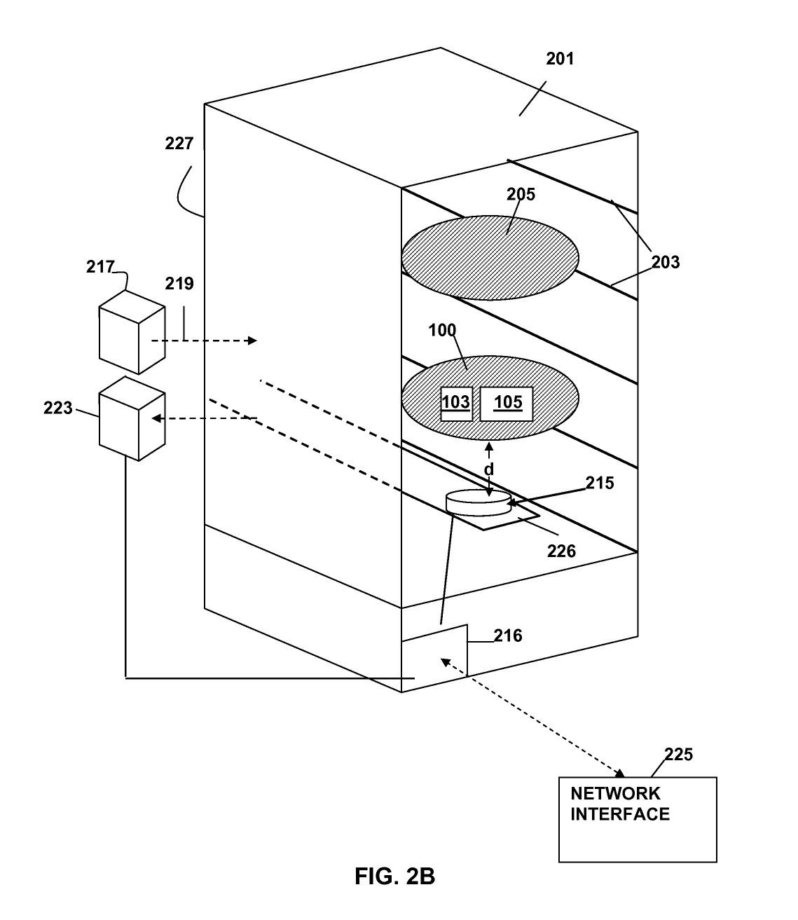

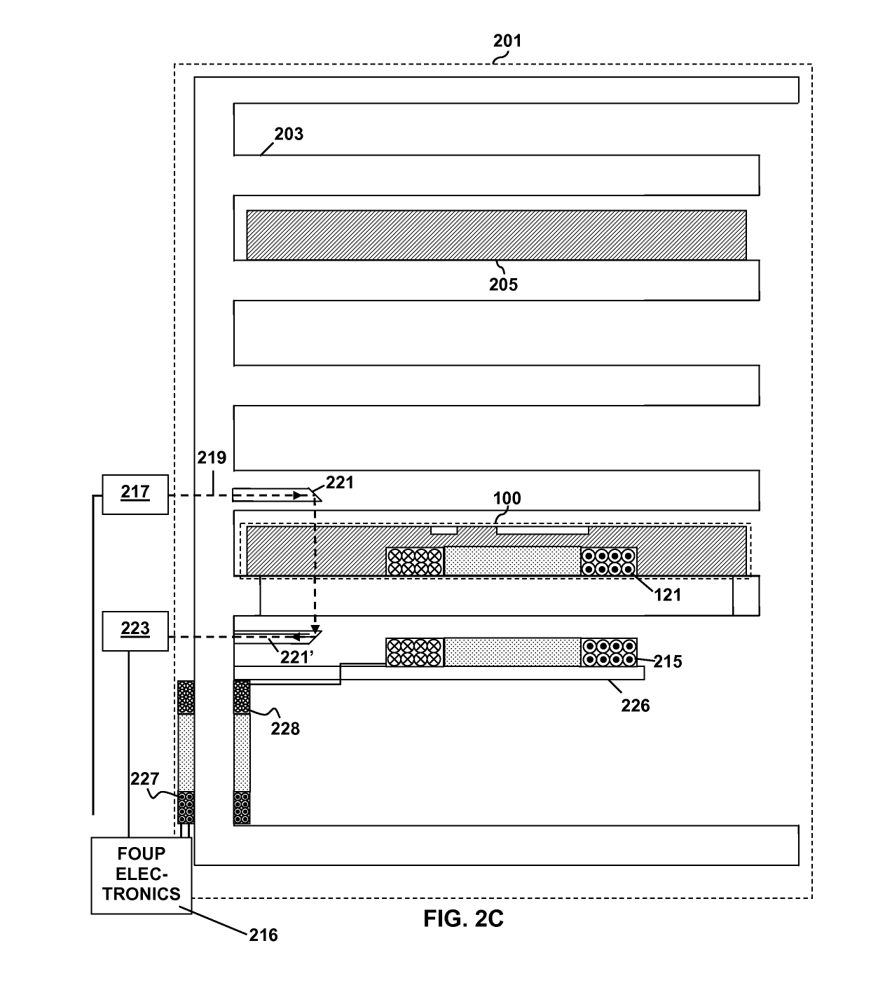

Existing sensor wafers have been configured such that the wafer coil 121 is scaled down in size to reduce the resistance associated with the coil. In such a configuration, obtaining optimal signal strength to facilitate communication between the FOUP coil and the wafer coil 121 often results in the FOUP coil coming into contact with the sensor wafer 100. This can introduce particle contamination into the measurement process, which may result in inaccuracies in the result. The wafer coil 121 generally includes one or more conductive (e.g., copper) windings in the form of a flat spiral coil having an inner diameter D1 and an outer diameter D. In order to overcome particle contamination, the wafer coil 121 according to an embodiment of the present invention may be configured to have a much larger outer diameter D (e.g., at least 50 mm) in order to allow for a greater distance between the FOUP coil and the wafer coil 121 during communication and power transfer. This greatly reduces the particle contamination involved with the measurement process and allows for the sensor wafer to be more widely used with particle sensitive applications. In order to assist with the non-contact transfer of information, the wafer coil 121 may include a transformer core so that the wafer coil 121 may be kept at a larger distance from the FOUP coil during power transfer and communication. In FIGS. 1B and 2A, (x) represents a coil coming out of the page, and (^{.}) represents a coil going into the page. To facilitate inductive coupling, the wafer coil 121 may be wound around an optional ferrite core. 119

The FOUP coil may transfer power to the wafer coil 121 through induction, and may also transmit data to the wafer coil 121 through modulation of a carrier frequency. The wafer coil 121 is coupled to both the energy storage device 103 and the measurement electronics 105. The power transferred from the FOUP coil to the wafer coil 121 is further transferred to the energy storage device 103 so that the sensor wafer 100 as a whole may be charged.

By way of example, and not by way of limitation, the wafer coil 121 may have an outside diameter between about 50 mm and the diameter of the substrate 101. By way of example, the outside diameter may be about 50 mm when the wafer coil 121 is operated at a distance of about 11 mm from the FOUP coil. The wafer coil 121 may be formed as a thin film circuit directly on the substrate 101. Alternatively, the wafer coil 121 may be a sub-assembly attached within a cavity or depression in the surface of the substrate 101 to maintain a low profile. The wafer coil 121 may have the same number of turns as the FOUP coil. By way of example, the wafer coil 121 may have about 5 to 20 turns.

FIG. 2A-2B illustrate a cross-sectional diagram and a perspective view of an interface system for exchanging power and/or data with a sensor wafer of the type shown in FIGS. 1A-1C. The system includes a wafer carrier, such as a FOUP 201 that has a plurality of slots 203 configured such that a sensor wafer 100 or a similarly sized and shaped semiconductor wafer 205 may rest comfortably in a slot 203. An example of a commercially-available FOUP is a type A300 FOUP available from Entegris, Inc. of Chaska, Minnesota. In the example shown in FIG. 1A, the sensor wafer 100 rests in the second to last slot of the FOUP 201 and another semiconductor wafer 205 rests in separate slot 203 above the sensor wafer 100. The sensor wafer 100 is configured to exchange data and receive power via a FOUP coil 215 that is mounted in an adjacent FOUP slot 203.

By way of example, the FOUP coil 215 includes one or more turns of electrically conductive (e.g., copper) wire that wind around a hat shaped ferrite core 213. In the example depicted in FIG. 2A, the FOUP coil 215 is situated on a disk-shaped support 211 installed in a slot next to the sensing wafer slot. The disk 211 may be made from a material that is compatible with a semiconductor processing environment, such as acrylic. The FOUP coil 215 may similarly be situated on a cantilevered strip 226 made of a high modulus material that extends from the back wall 227 of the FOUP 201 as shown in FIG. 2B. The FOUP coil 215 may transfer power to the wafer coil 121 through induction, and may also transmit data to the wafer coil 121 through the modulation of a carrier frequency. The wafer coil 121 is coupled to the sensor wafer's energy storage device 103 and measurement electronics 105, and may further transmit power and data from the FOUP coil 215 to the sensor wafer's energy storage device and measurement electronics respectively. Likewise, the wafer coil 121 may communicate with the FOUP coil 215 by altering its load such that data is transmitted during reflection from the wafer coil 121 to the FOUP coil 215. The FOUP coil 215 may include N′ of turns of wire wound around an optional ferrite core 213. The FOUP coil 215 may have an outer diameter D′ equal to the diameter D of the wafer coil 121. The diameter and number of windings in the FOUP coil 215 are preferably the same as the diameter and number of windings of the wafer coil 121.

The FOUP coil 215 may be coupled to an electronics module 216, referred to herein as FOUP electronics. The FOUP electronics 216 may provide power to the FOUP coil 215 for charging the energy storage device 103 on the sensor wafer 100. In addition, the FOUP electronics 216 may include processor logic and/or a memory and transceiver to facilitate exchange of data between the FOUP electronics 216 and the electronics module 105 on the sensor wafer 100.

The FOUP coil 215 is preferably situated and oriented in the FOUP such that it is concentric with the wafer coil 121 when the sensor wafer 100 is positioned in a slot 203 on the FOUP 201. To determine the distance d between the wafer coil 121 and the FOUP coil 215 necessary to facilitate optimal data and power transmission, a ratio between the wafer coil diameter and the distance d may be determined experimentally. In the example shown, by increasing the diameter of the wafer coil 121 to a diameter greater than 50 mm, the distance d between the wafer coil 121 and the FOUP coil 215 may be increased to 20 mm or greater. Preferably, however, wafer coil 121 is at least 8 mm, e.g., between 8 mm and 12 mm, from the FOUP coil 215 when the sensor wafer 100 is in its slot 203 in the FOUP 201. Generally, the frequency of the voltage signal applied to the FOUP coil 215 is in the range of 1 to 3 Megahertz and the amplitude of the signal is sufficient to supply an RMS current of about 100 to 200 milliamps to the FOUP coil.

It was initially believed, even by the inventors themselves, that such a spacing was simply too large and the coil resistance too great to allow for effective inductive coupling between the FOUP coil 215 and the wafer coil 121. However, a system having a wafer coil and FOUP coil with the following dimensions was found to work effectively.

As proof of concept, a FOUP coil and wafer coil were built. Each coil had an outside diameter of 50 mm and included 10 turns. The coils were separated from each other by a distance of about 11 mm. The FOUP coil was operated as a series LC (tuned trap) circuit at a frequency of about 2 MHz.

In an alternative embodiment illustrated in FIG. 2B, However, when the FOUP coil 215 is situated on the cantilevered strip of high modulus material extending from the back wall 227 of the FOUP 201, as described above, the distance between the wafer coil and the FOUP coil is reduced because the cantilevered high modulus strip needs to be in closer proximity to the sensor wafer 100 in order to optimally transmit data and transfer power. Creating distance between the FOUP coil 215 and the sensor wafer 100 eliminates the particle contamination introduced when the FOUP coil 215 is in contact with the sensor wafer 100.

This interface system may optionally have an optical detector 223 and a network interface 225. The network interface 225 is configured to allow for bi-directional communication between the FOUP electronics 216 and any computers within a network. In the example shown, the optical detector 223 is configured to detect the presence of a sensor wafer 100 through the side of the FOUP 201. An optical beam 219 initially passes from a source 217 through the transparent sidewall of the FOUP 201. The optical light guides 221, 221′ may be index matched with the wall of the FOUP 201 such that no reflection or refraction of the optical beam 219 occurs at the interface between the light guides 221, 221′ and the side wall of the FOUP 201. Optical coupling through the wall of the FOUP 201 avoids having to drill a hole through the wall. The optical beam 219 then travels via a first transparent light guide 221 and is reflected at a beveled end of the light guide 221 through a short gap to a second light guide 221′, which is oriented in a mirror image configuration with respect to the first light guide 221. The second light guide 221′ guides the optical beam 219 back towards the wall of the FOUP 201 and into a detector 223, which may be coupled to the FOUP electronics 216. When a sensor wafer 100 is situated in the beam path, the wafer interrupts the optical beam 219 and a signal produced by the detector 223 changes as a result. The signal from the detector 223 may be coupled to the FOUP electronics 216 so that the FOUP electronics 216 are notified of the presence of the wafer. It is important to note that the optical source 217, optical detector 223, light guides 221, 221′ and optical beam 219 may be configured to detect the presence of a sensor wafer through the transparent back wall 227 of a FOUP 201 rather than the transparent sidewall.

By way of example, the FOUP coil 215 may be formed on a printed circuit board (PCB) in a single layer of spiral turns with an outer diameter of about 50 mm. The wafer coil may have a dual layer of spiral turns with an outer diameter of about 50 mm formed on a backside of the substrate 101. One or more of the light guides 221 for the wafer presence detector may also be implemented in the PCB. In some embodiments a tertiary coil may be formed on the support 211 on a side opposite the secondary coil and used in conjunction with the primary coil. This forms a multiple tuned transformer coupling.

FIG. 2C illustrates an embodiment in which the FOUP electronics may be located entirely outside the FOUP 201 and penetration of the FOUP wall may be avoided. In this example, the FOUP electronics are coupled to a primary induction coil 227 mounted to a wall of the FOUP 201. In the example illustrated, the primary induction coil 227 is mounted to a back wall of the FOUP. A secondary induction coil 228 is located inside the FOUP 201 proximate the primary induction coil 227 on the opposite side of the wall. The wall is preferably made of a material that is sufficiently electromagnetically transparent that the primary and secondary coils 227, 228 may be inductively coupled to each other. The secondary induction coil 227 is electrically coupled to the FOUP coil 215, which is mounted to the cantilevered strip 226 in this example. Electrical power and/or control signals from the FOUP electronics 216 may be transferred to the FOUP coil 215, via inductive coupling between the primary and secondary induction coils 227,228. Data may be transferred from the sensor wafer 100 via the wafer coil 121, FOUP coil 215 and induction coils 227, 228. Use of inductive coupling as shown in FIG. 2C allows the FOUP electronics 216 to be located outside the FOUP 201 without having to pierce the wall of the FOUP 201 in order to couple the FOUP electronics to the FOUP coil 215. The primary and secondary inductive coils may be mounted to the inside and outside of the wall of the FOUP in a non-penetrating manner, e.g., with suitable adhesives.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. An interface system for sensor wafer, comprising:
a) a sensor wafer having a substrate, one or more sensors mounted to the substrate, an electronics module mounted to the substrate and coupled to the one or more sensors, a energy storage device mounted to the substrate and coupled to the electronics module, and a secondary inductive coil attached to a surface of the sensor wafer, and coupled to the electronics module of the sensor wafer, having a diameter of at least 50 millimeters; and
b) a primary inductive coil attached to a front opening universal pod (FOUP), wherein the primary inductive coil, is situated and oriented in the FOUP such that the primary inductive coil is concentric with the secondary inductive coil and at least 8, but less than 12 millimeters from the sensor wafer when the sensor wafer is stored in a slot in the FOUP.

2. The interface system of claim 1, further comprising a FOUP electronics module coupled to the primary coil.

3. The interface system of claim 1, further comprising a non-contact sensor coupled to the FOUP electronics module, wherein the non-contact sensor is configured to detect a presence or absence of the sensor wafer in the slot in the FOUP and communicate the presence or absence of the sensor wafer to the FOUP electronics module.

4. The interface system of claim 3, wherein the non-contact sensor includes an optical source and an optical detector.

5. The interface system of claim 4, wherein the non-contact sensor further includes a first and second light guide attached to a transparent wall of the FOUP wherein the first and second light guides are configured to transmit an optical beam from the optical source across a gap and towards the detector, wherein the gap is situated such that the sensor wafer interrupts the optical beam when the sensor wafer is in the slot in the FOUP.

6. The interface system of claim 1, further comprising a ferrite core, wherein the primary coil is wound around the ferrite core.

7. The interface system of claim 1, further comprising a ferrite core, wherein the secondary coil is wound around the ferrite core.

8. The interface system of claim 1, whereby the primary inductive coil is situated on a wafer shaped disk permanently installed in the FOUP.

9. The interface system of claim 1, wherein the primary inductive coil is situated on a cantilevered high modulus strip installed in the FOUP.

10. The interface system of claim 1, wherein the sensor wafer includes an energy storage device coupled to at least one sensor and the electronics module on the sensor wafer.

11. The interface system of claim 1, wherein the sensor wafer includes a substrate that has the same diameter as one or more production wafers that fit in slots in the FOUP.

12. The interface system of claim 1, further comprising, a first inductive coil mounted at an inside of a wall of the FOUP and a second inductive coil located outside the wall of the FOUP proximate the first inductive coil, wherein the first inductive coil primary inductive coil

13. A sensor wafer for measuring process parameters, comprising:
a) a substrate;
b) one or more sensors mounted to the substrate;
c) an electronics module mounted to the substrate and coupled to the one or more sensors;
d) an energy storage device mounted to the substrate and coupled to the electronics module; and
e) an inductive coil mounted to the substrate and coupled to the energy storage device and/or electronics module, the inductive coil having a diameter of at least 50 millimeters.

14. A method for charging or exchanging data with a sensor wafer stored in a front opening universal pod (FOUP), comprising:
a) placing a sensor wafer in a slot in the FOUP, wherein the sensor wafer includes a secondary inductive coil coupled to an electronics module or energy storage device, wherein the secondary inductive coil is 50 mm or greater in diameter, wherein the secondary inductive coil is oriented concentric with and at least 8 mm away from a primary inductive coil attached to the FOUP when the sensor wafer is in the slot in the FOUP; and
b) transferring power from the primary inductive coil to the secondary inductive coil to charge the energy storage device or exchanging data between the primary inductive coil and the secondary inductive coil coupled to the sensor.

15. The method of claim 14, further comprising detecting the presence of the sensor wafer in the slot and initiating transferring power or exchanging data in response to detecting the presence of the sensor wafer in the slot.

16. The method of claim 15, wherein detecting the presence of the sensor wafer in the slot includes detecting interruption of an optical beam when the sensor is positioned in the slot.
